(19) United States
(12) Patent Application Publication
(10) Pub. No.: US 2008/0194253 A1
(43) Pub. Date: Aug. 14, 2008

(54) Search method of a roaming service

(75) Inventors: Wen-Yi Kuo, Neihu District (TW); Yueh-Feng Lee, Taoyuan City (TW); Yi-Hao Chang, Yong-Ho City (TW)

Correspondence Address: SUGHRUE MION, PLLC, 2100 PENNSYLVANIA AVENUE, N.W., SUITE 800, WASHINGTON, DC, 20037, US

(73) Assignee: BANDRICH INC., Sindian City (TW)

(21) Appl. No.: 11/705,025

(22) Filed: Feb. 12, 2007

(51) Int. Cl. H04Q 7/20

(52) U.S. Cl. 455/433

(57) ABSTRACT

A search method of a roaming service for registering a mobile station to a network service includes searching for a home public land mobile network (HPLMN) when the mobile station is first switched on or recovering from lack of service, or sorting an available public land mobile network (PLMN) list, or using a scaling method to obtain a temporary timer period for a periodic search. Sorting the available PLMN list includes sorting according to a location-based order of preferred PLMNs, or sorting according to a data transfer speed supported by each PLMN. The scaling method includes examining a change ratio in the available PLMN list, or a data transfer speed of the RPLMN, or a status of Mobile Country Code (MCC) in order to obtain the temporary timer period.

### BACKGROUND

1. Field of Invention

The present invention relates to the field of mobile communications. More particularly, the present invention relates to a search method of a roaming service for a mobile communication.

2. Description of Related Art

In mobile communications systems, e.g. a 2^{nd} generation system domain like a Global System for Mobile Communication GSM domain and a 3^{rd} generation system domain like a Universal Mobile Telecommunication System UMTS domain, a set of guidelines exists to facilitate a roaming service, for example, in 3G TS 23.122 v5.3.9, “NAS Functions related to Mobile Station (MS) in idle mode”, such that a location registration procedure is performed to allow the subscriber to roam from one Public Land Mobile Network (“PLMN”) to another.

With the roaming service, a subscriber is not required to change the Mobile Station (“MS”) and the Subscriber Identity Module/Universal Subscriber Identity Module (“SIM/USIM”) when switching to use one PLMN from another.

For example, to allow international roaming when the subscriber travels abroad, the location registration procedure is performed and it registers the subscriber to a service domain operated by a Visited Public Land Mobile Network (“VPLMN”) operator. Therefore, the subscriber can make and receive calls in the VPLMN as he is in a Home Public Land Mobile Network (HPLMN). When switched on, or recovered from lack of service, the MS first performs the location registration to a Registered Public Land Mobile Network (“RPLMN”). If not successful, it then performs the location registrations to the available networks one by one until success, in the following order:
(1) HPLMN, whether the HPLMN is available or not
(2) Follow the order of a UPLMN list, wherein the UPLMN list is stored in a “User controlled PLMN selector” data field in the SIM/USIM
(3) Follow the order of an OPLMN list, wherein the OPLMN list is stored in a “Operator controlled PLMN selector” data field in the SIM/USIM
(4) Other PLMNs with a received signal level above a predetermined value specified in the GSM/3GPP specification, in random order
(5) All other PLMNs, in the descending order of signal strength

The roaming service requires a periodical search for a more preferred PLMN according to the GSM/3GPP specification. A scan timer period (T minutes) may be stored in the SIM/USIM such that the periodical search is performed after the subscriber has been registered on the VPLMN. In every T minutes, the periodical search is performed to check if there is a more preferred PLMN available to register in order to obtain the service.

However, the periodical search of the roaming service for a preferred PLMN consumes energy, i.e. the battery life of the MS, especially if T is set to a small value, which results in the consumption a lot of energy.

The MS performs the location registration to the RPLMN prior to the location registration to the HPLMN, when the RPLMN and the HPLMN are both available after the MS is switched on or recovered from lack of service. This prevents the MS to return to the HPLMN and stop the roaming service as soon as possible, and the MS would return to the HPLMN after the later periodic search for the more preferred PLMNs.

Nevertheless, the order of the preferred networks used for trying the location registrations to the available networks is not adaptive to the location of the MS. Thus the user or the operator of the HPLMN can't assign different orders for different locations.

For the forgoing reasons, there is a need for a new periodical search method of a roaming service for the mobile communication.

### SUMMARY

According to one embodiment of the present invention, a search method of a roaming service for registering a mobile station to a network service comprises searching for a home public land mobile network (HPLMN) when the mobile station is first switched on or recovered from lack of service, registering to the HPLMN when it is found, and searching for and registering to a RPLMN when the mobile station can not find the available base station of the HPLMN, or the available base station of the HPLMN does not support a high-speed data transfer, or a location registration to the HPLMN is unsuccessful. Searching for and registering to the HPLMN includes recording the HPLMN as the registered public land mobile network (RPLMN) and stopping the roaming service when there is an available base station of the HPLMN and the available base station of the HPLMN supports a high-speed data transfer.

According to one embodiment of the present invention, a search method of a roaming service for registering a mobile station to a network service comprises searching for a registered public land mobile network (RPLMN), registering to the RPLMN when it is found, and when a scan timer expires, or no RPLMN information is found, or the base station of the RPLMN is not available, or the location registration to the RPLMN is unsuccessful, performing the steps of: (a1) updating an available public land mobile network (PLMN) list; and (a2) performing a location registration according to the available PLMN list. The step (a1) of updating the available PLMN list comprises sorting available PLMNs using a location-based PLMN table, or sorting the available PLMNs by the data transfer speed they support.

According to one embodiment of the present invention, updating an available PLMN list includes creating the location-based PLMN table wherein several preferred PLMN lists are stored, each for a different location.

According to one embodiment of the present invention, updating an available PLMN list includes sorting the preferred PLMNs list in a descending order according to the data transfer speed of the preferred PLMNs such that the first PLMN list in the PLMN has the highest data transfer speed.

According to one embodiment of the present invention, a search method of a roaming service for registering a mobile station to a network service, comprising (a1) updating an available public land mobile network (PLMN) list; and (a2) determining whether a registered public land mobile network (RPLMN) is a home public land mobile network (HPLMN), when the RPLMN is not the HPLMN, then using a scaling method to update a scan timer period, obtain a temporary timer period, and start a scan timer with the temporary timer period. The scaling method examines a changed ratio in the available PLMN list, or the data transfer speed of the RPLMN, or a status of Mobile Country Codes (MCC) to obtain the temporary timer period.

According to one embodiment of the present invention, the scaling method used in a search method for a roaming service for registering a mobile station to a network service comprises comparing a percentage changed in the available PLMN list and a predetermined ratio, when the percentage changed in the available PLMN list is greater than the predetermined ratio, then shortening the scan timer period, and when the percentage changed in the available PLMN list is smaller than the predetermined ratio, lengthening the scan timer period. The scan timer period is controlled within a predetermined scan timer period range, and the temporary timer period is set to the value of the scan timer period.

According to another embodiment of the present invention, the scaling method used in a search method of a roaming service for registering a mobile station to a network service comprises setting the temporary timer period to the value of the scan timer period before examining whether the RPLMN supports a high-speed data transfer, and when the RPLMN does not support the high-speed data transfer, then shortening the temporary timer period. The temporary timer period is controlled within a predetermined scan timer period range.

According to another embodiment of the present invention, the scaling method using in a search method of a roaming service for registering a mobile station to a network service comprises setting the temporary timer period to the value of the scan timer period before examining whether the MCC of the RPLMN is the same as the MCC of the HPLMN, and when the MCC of the RPLMN is different from the MCC of the HPLMN, then shortening the temporary timer period. The temporary timer period is controlled within a predetermined scan timer period range.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flowchart of searching for and registering to a home public land mobile network prior according to one embodiment of this invention;

FIG. 2 is a flowchart of searching for and registering to a registered public land mobile network according to one embodiment of this invention;

FIG. 3 is a flowchart of a search method of roaming service according to one embodiment of this invention;

FIG. 4 is a flowchart of a search method of roaming service according to one embodiment of this invention;

FIG. 5 is a flowchart of a scaling method examines a changed ratio in the available PLMN list according to one embodiment of this invention;

FIG. 6 is a flowchart of a scaling method determining the period by the data transfer speed of the RPLMN according to one embodiment of this invention; and

FIG. 7 is a flowchart of a scaling method determining the period by the status of the mobile country code (MCC) according to one embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

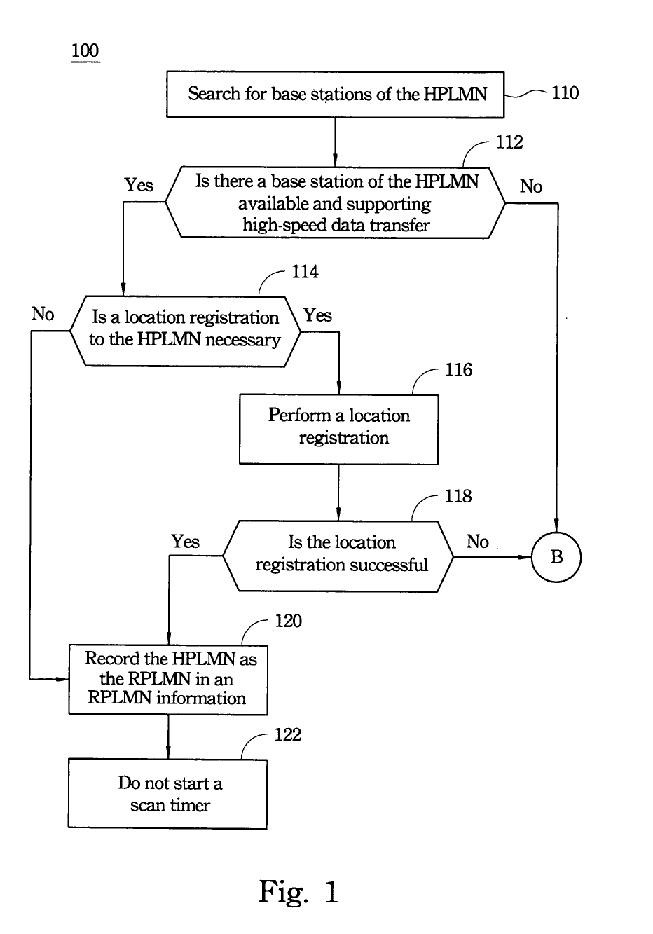

FIG. 1 is a flowchart 100 of searching for and registering a home public land mobile network (“HPLMN”) according to one embodiment of this invention. In Step 110, the mobile station searches for base stations belong to a HPLMN, e.g. when a mobile station is first switched on or recovering from lack of service. Step 112 examines the availability of the base station of the HPLMN and whether the base station of the HPLMN supports a high-speed data transfer. When the base station of the HPLMN for the mobile station is available and supports the high-speed data transfer, the necessity of a location registration to the HPLMN is determined in Step 114. If the last PLMN the mobile station successfully registered to is the HPLMN, and the mobile station is still in the same location area where it performed the location registration, then a new location registration is not necessary.

When a new location registration is necessary, the location is registered in Step 116, the status of the location registration is examined in Step 118. When the location registration is successful, the mobile station records the HPLMN as the registered public land mobile network (RPLMN) in Step 120, and it does not start the scan timer in Step 122, which means the mobile station finds the preferred PLMN and stops the periodic search.

Those skilled in the art will recognize that a scan timer period is used in order to perform a periodic search. The periodical search is preferably within the range of about 2 minutes˜480 minutes.

When the base station of the HPLMN is unavailable or the base station of the HPLMN does not support the high-speed data transfer in Step 112, or when the location registration in Step 118 is unsuccessful, the search method then goes to point B.

When the mobile station does not require performing the location registration to the HPLMN in Step 114, the mobile station records the HPLMN as the RPLMN in Step 120, and then continues with the previously described procedures.

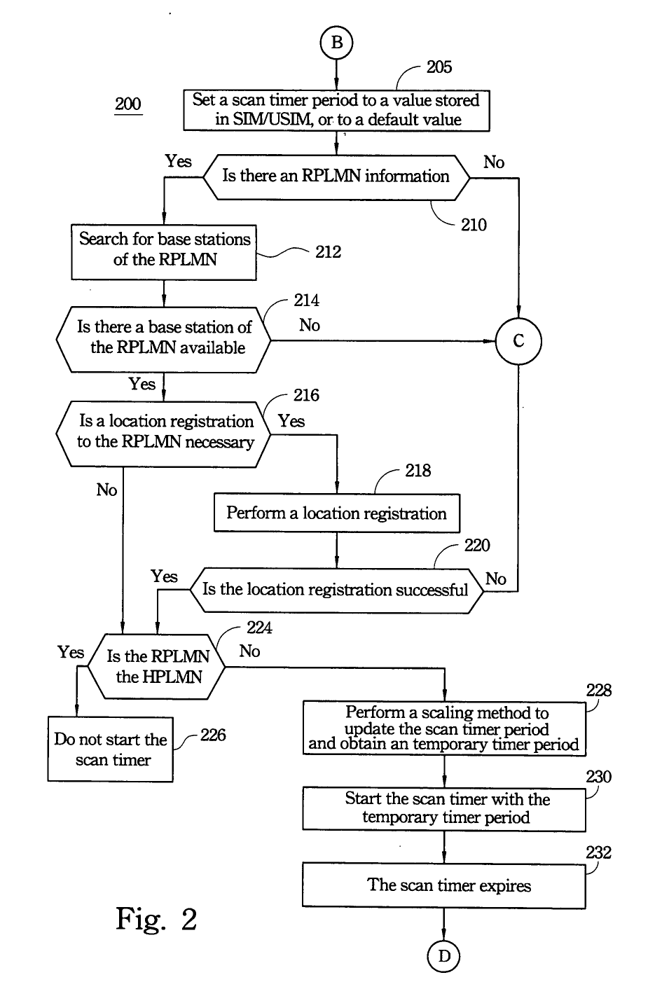

FIG. 2 is a flowchart of searching for and registering a registered public land mobile network according to one embodiment of this invention. The flowchart of searching for and registering an RPLMN 200 starts from point B. The mobile station sets a scan timer period to a value stored in SIM/USIM, or to a default value in Step 205. Step 210 determines whether or not there is an RPLMN information. The RPLMN information records the PLMN which the mobile station has last successfully registered to. When there is the RPLMN information, the mobile station searches for base stations of the RPLMN in Step 212, and determines whether the base station of the RPLMN is available in Step 214. When the base station of the RPLMN is available, the mobile station examines whether the mobile station must perform a new location registration to the RPLMN in Step 216. A new location registration is necessary when the mobile station is no longer in the area where it performed last successful location registration. When a new location registration to the RPLMN is necessary, the mobile station performs the location registration in Step 218. Next, in Step 220, the status of the location registration is examined. When the location registration is successful the RPLMN is examined in Step 224 to determine whether the RPLMN is the HPLMN or not. When the RPLMN is the HPLMN, the mobile station does not start the scan timer in Step 226. When the RPLMN is not the HPLMN, the mobile station performs a scaling method to update the scan timer period and obtain an temporary timer period in Step 228, and starts the scan timer with the temporary timer period in Step 230. In Step 232, when the scan timer expires, the search method goes to Point D.

When the location registration to the RPLMN in Step 216 is not necessary, the RPLMN is examined in Step 224 to determine whether the RPLMN is the HPLMN or not, and then continues with the previously described procedures.

When there is no information of RPLMN in Step 210, or when the base station of the RPLMN is not available in Step 214, or when the location is not successfully registered in Step 220, the search method goes to Point C.

In one embodiment, updating the available PLMN list includes creating a location-based PLMN table storing several lists of the preferred PLMNs, each of one different area. Multiple areas may belong to a same country. Table 1 shows an example of such a PLMN table.

TABLE 1

| Locations | | Preferred PLMNs | | |
|---|---|---|---|---|
| Country | Area | 1^{st} preferred | 2^{nd} preferred | 3^{rd} preferred |
| Italy | Rome | Huntchinson | Vodafone | TIM |
| | | Italy | | |
| Italy | Milan | Tim | Orange | Vodafone |
| Germany | Hamburg | T-Mobile D | E-Plus | — |
| Germany | Berlin | O2 | D2 | E-Plus |
| | | | Vodafone | |
| Germany | Hanover | E-Plus | O2 | T-Mobile D |
| United Kingdom | Edinburgh | BT Mobile | Orange | O2 |

Referring to row 3 of Table 1, when the mobile station is in Rome, Italy, then the 1^{st} preferred network is Huntchingson Italy, the 2^{nd} preferred network is Vodafone, and the 3^{rd} preferred network is TIM. Referring to row 4 of Table 1, when the mobile station is in Milan, Italy, then the 1^{st} preferred network is TIM, the 2^{nd} preferred network is Orange, and the 3^{rd} preferred network is Vodafone.

More specifically, the mobile station may perform the following sorting order to update the available PLMN list:
(1) HPLMN
(2) Follow the order of a UPLMN list
(3) Follow the order of the preferred PLMN list corresponding to the area where the mobile station is currently in
(4) Other PLMNs with received signal level above a predetermined value specified in the GSM/3GPP specification, in random order
(5) All other PLMNs, in the descending order of signal strength

In another embodiment, updating of an available PLMN list includes sorting the preferred PLMNs in descending order of the data transfer speed of the preferred PLMNs. More specifically, the mobile station may use the following sorting order to update the available PLMN list:

(1) 3G PLMNs:
1.1) HPLMN
1.2) Follow the order of a UPLMN list
1.3) Follow the order of an OPLMN list
1.4) Other PLMNs with received signal level above a predetermined value specified in the GSM/3GPP specification, in random order

(2) 2G PLMNs
2.1) HPLMN
2.2) Follow the order of a UPLMN list
2.3) Follow the order of a OPLMN list
2.4) Other PLMNs with a received signal level above a predetermined value specified in the GSM/3GPP specification, in random order

(3) Other 2G or 3G PLMNs, in the descending order of signal strength

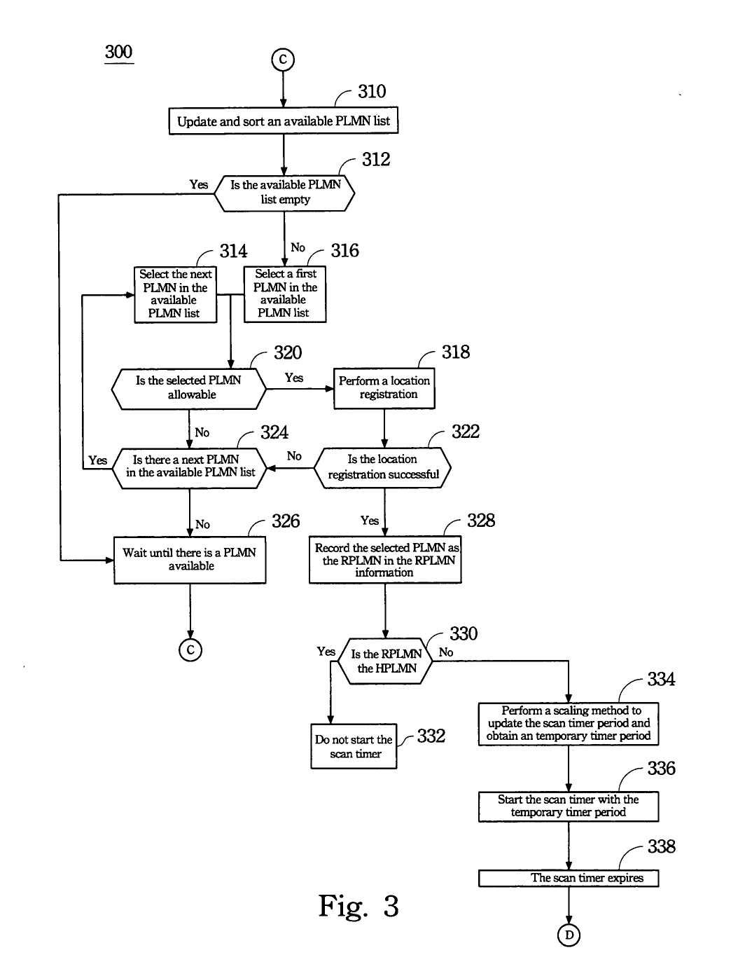

FIG. 3 is a flowchart of a search method of roaming service according to one embodiment of this invention. The flowchart of search method of a roaming service 300 starts from point C. In Step 310, an available PLMN list is updated and sorted. In Step 312, the mobile station determines the status of the available PLMN list. When the available PLMN list is not empty, the mobile station in Step 316 selects a first PLMN in the available PLMN list, and the selected PLMN is examined in Step 320 to determine whether or not the selected PLMN is allowable. When the selected PLMN is allowable, the location registration is performed in Step 318, and the status of the location registration is then examined in Step 322. When the location registration is successful, in Step 328 the mobile station records the selected PLMN as the RPLMN in the RPLMN information and the RPLMN is examined in Step 330 to see whether the RPLMN is an HPLMN. When the RPLMN is the HPLMN, the mobile station does not start the scan timer of the mobile station in Step 332. When the RPLMN is not an HPLMN, the mobile station performs a scaling method to update the scan timer period and obtain an temporary timer period in Step 334, and starts the scan timer with the temporary timer period in Step 336. In Step 338, when the scan timer expires, the search method goes to Point D.

In Step 320, when the selected PLMN is not allowable, the mobile station determines whether there is a next PLMN in the available PLMN list in Step 324. When there is no next PLMN in the available PLMN list, the mobile station waits until there is a PLMN available in Step 326, and the search method goes to Point C.

When there is the next PLMN in the available PLMN list in Step 324, the mobile station selects the next PLMN in the available PLMN list in Step 314, and the selected PLMN is examined in Step 320 to determine whether or not the selected PLMN is allowable, and then continues with the previously described procedures.

In Step 312, when the available PLMN list is empty, the mobile station waits until there is a PLMN available in Step 326, and the search method goes to Point C.

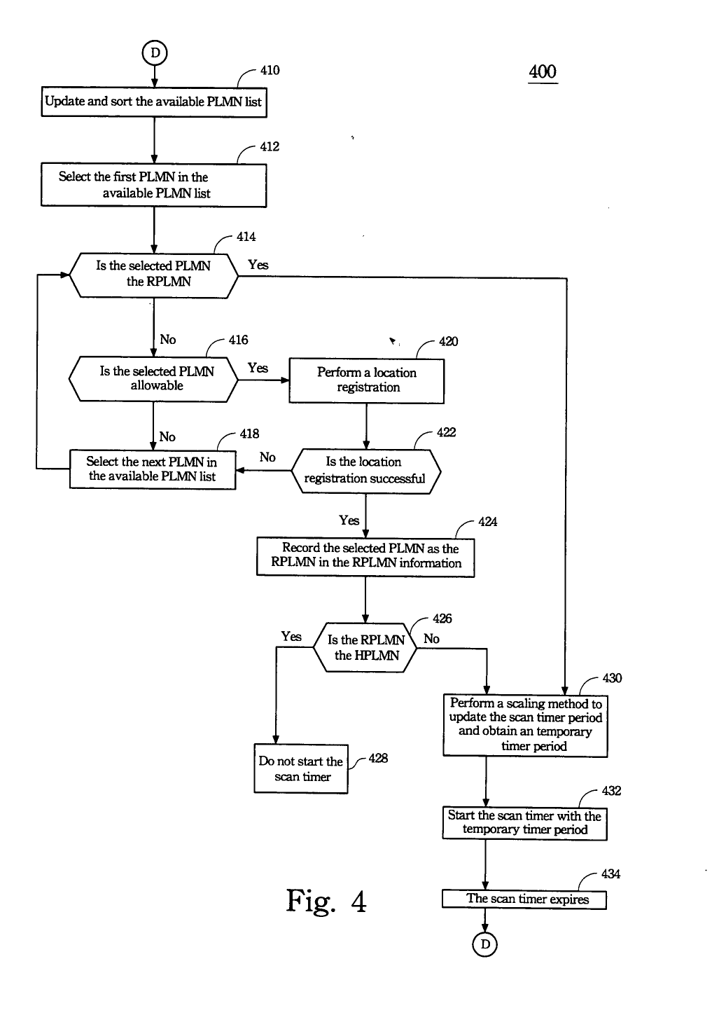

FIG. 4 is a flowchart of a search method of roaming service according to one embodiment of this invention. The flowchart of search method of a roaming service 400 starts from point D when the scan timer expires. In Step 410, the available PLMN list is updated and sorted, and the mobile station selects the first PLMN in the available PLMN list in Step 412. In Step 414, the mobile station determines whether the selected PLMN is the RPLMN. When the selected PLMN is not the RPLMN, the selected PLMN is examined in Step 416 to see whether the selected PLMN is indeed allowable. When the selected PLMN is allowable, the location registration is performed in Step 420, and then the success or failure of the location registration is checked in Step 422. When the location registration is successful, the mobile station records the selected PLMN as the RPLMN in the RPLMN information in Step 424, and examines whether the RPLMN is the HPLMN in Step 426. When the RPLMN is not the HPLMN, the scaling method is performed in Step 430 to update the scan timer period and obtain an temporary timer period, and the mobile station starts the scan timer with the temporary timer period in Step 432. In Step 434, when the scan timer expires, the search method goes to Point D. In Step 426, when the RPLMN is the HPLMN, the mobile station does not start the scan timer.

In Step 414, when the selected PLMN is the RPLMN, the mobile station performs a scaling method in Step 430 to update the scan timer period and obtain an temporary timer period, and then continues with the previously described procedures.

In Step 416, when the selected PLMN is not allowable, the mobile station in Step 418 selects the next PLMN in the available PLMN list, and determines whether the selected PLMN is the RPLMN in Step 414, and then continues with the previously described procedures.

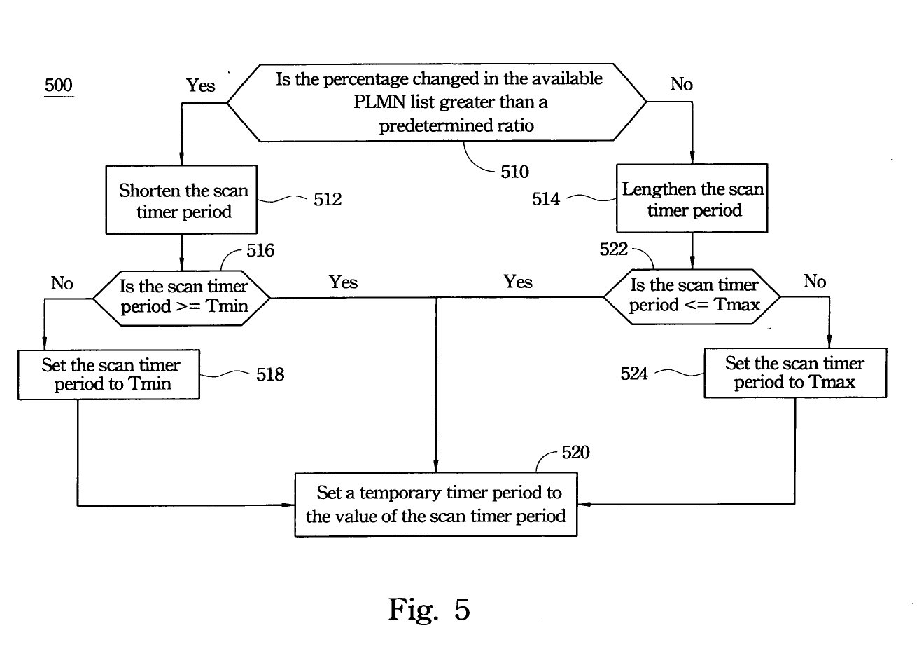

FIG. 5 is a flowchart of scaling method which examines a changed ratio in the available PLMN list according to one embodiment of this invention. The scaling method 500 comprises comparing a percentage changed in the available PLMN list and a predetermined ratio. The predetermined ratio is set up to determine how much change in the available PLMN list is significant in order to adjust the scan timer period accordingly. When the percentage changed in the available PLMN list is greater than the predetermined ratio, the scan timer period is shortened, and when the percentage changed in the available PLMN list is less than the predetermined ratio, the scan timer period is lengthened. The scaling method further comprises controlling the scan timer period within a predetermined scan timer period range (between Tmin and Tmax). The predetermined scan timer period range is set up to prevent the scan timer period from being too small and consuming too much power to search for the more preferred PLMNs, or to prevent the scan timer period from becoming too big such that the mobile station can't quickly find the more preferred PLMNs when some becomes available.

More specifically, Step 510 compares whether a percentage changed in the available PLMN list is greater than a predetermined ratio. When the percentage changed in the available list is greater than the predetermined ratio, the scan timer period is shortened in Step 512, and the scan timer is examined to be greater than or equal to a minimum scan timer period (Tmin) in Step 516. When the scan timer period is greater than the minimum scan timer period, a temporary timer period is set to the value of the scan timer period in Step 520.

In Step 516, when the scan timer period is smaller than the minimum scan timer period (Tmin), the scan timer is set to the minimum scan timer period (Tmin) in Step 518, and a temporary timer period is set to the value of the scan timer period in Step 520.

In Step 510, when the percentage changed in the available list is smaller than the predetermined ratio, the mobile station lengthens the scan timer period in Step 514 and then examines whether the scan timer is smaller than or equal to a maximum scan timer period (Tmax) in Step 522. When the scan timer period is smaller than the maximum scan timer period (Tmax), a temporary timer period is set to the value of the scan timer period in Step 520. In Step 522, when the scan timer period is greater than the maximum scan timer period (Tmax), the scan timer is set to the maximum scan timer period (Tmax) in Step 524, and a temporary timer period is set to the value of the scan timer period in Step 520.

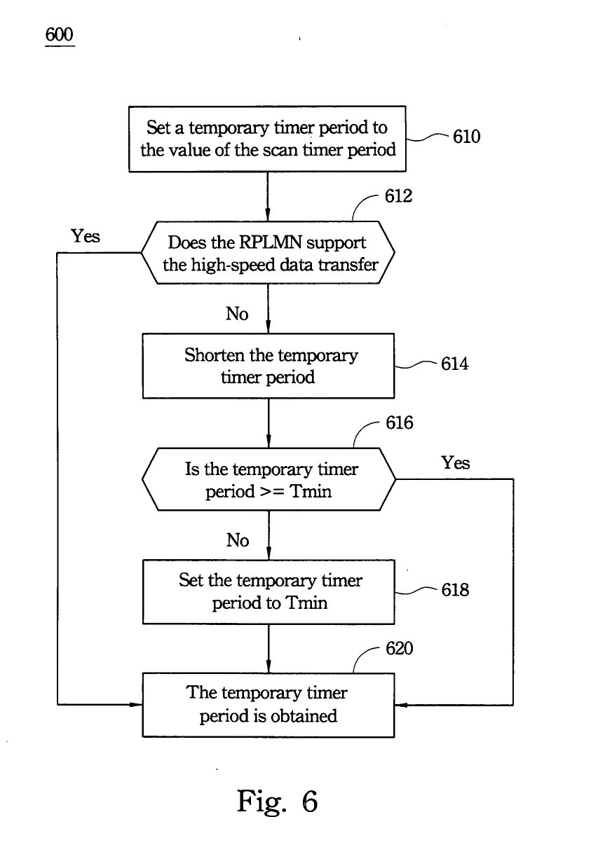

FIG. 6 is a flowchart of a scaling method which checks the data transfer speed of the RPLMN according to one embodiment of this invention. Scaling method 600 comprises setting a temporary timer period to the value of the scan timer period, and examining whether the RPLMN supports high-speed data transfer. When the RPLMN does not support the high-speed data transfer, then the temporary timer period is shortened. The scaling method further comprises controlling the temporary timer period within a predetermined scan timer period range (no less than Tmin). The temporary timer period is prevented from being too small and consuming power for the searches of the more preferred PLMNs.

In Step 610, a temporary timer period is set to the value of the scan timer period. In Step 612 the mobile station examines whether the RPLMN supports high-speed data transfer (e.g. 3G PLMN). When the RPLMN does not support the high-speed data transfer, the temporary timer period is shortened in Step 614, and then the mobile station examines whether the temporary timer period is greater than or equal to a minimum scan timer period (Tmin) in Step 616. When the scan timer period is greater than or equal to the minimum scan timer period (Tmin), the temporary timer period is obtained in Step 620. When the scan timer period is smaller than the minimum scan timer period (Tmin) in Step 616, the temporary timer period is set to the minimum scan timer period (Tmin) in Step 618, and the temporary timer period is obtained in Step 620.

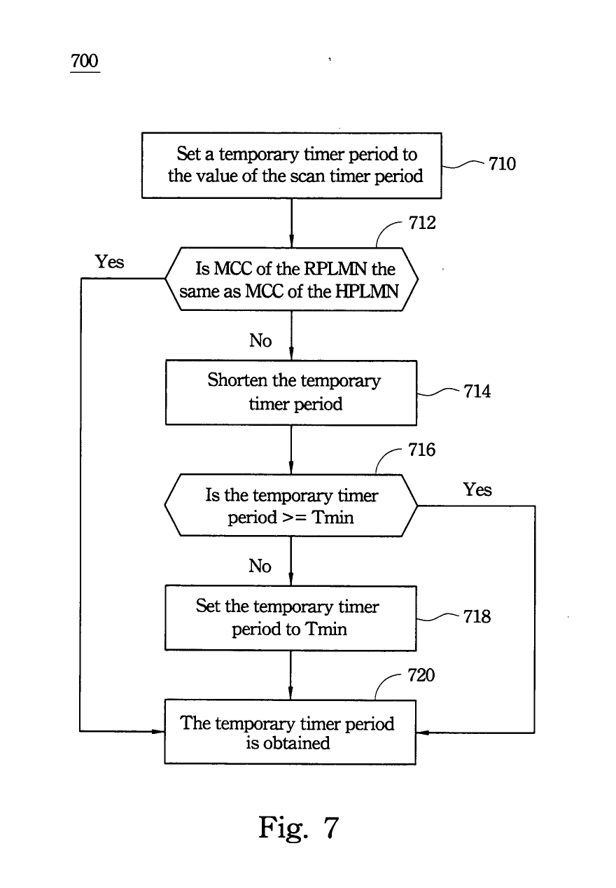

FIG. 7 is a flowchart of scaling method which checks the status of a mobile country code according to one embodiment of this invention. The scaling method 700 comprises setting a temporary timer period to the value of the scan timer period, and examining whether the MCC (Mobile Country Code) of the RPLMN is the same as the MCC of the HPLMN. When the MCC of the RPLMN is different from the MCC of the HPLMN (i.e. international roaming), the temporary timer period is shortened. The scaling method further comprises controlling the temporary timer period within a predetermined scan timer period range (no less than Tmin).

In Step 710, a temporary timer period is set to the value of the scan timer period. In Step 712 the MCC of the RPLMN is evaluated to see whether the MCC of the RPLMN is the same as the MCC of the HPLMN. When the MCC of the RPLMN is different from the MCC of the HPLMN, the temporary timer period is shortened in Step 714 and then in Step 716 the temporary timer period is examined to see whether the temporary timer period is greater than or equal to the minimum scan timer period (Tmin). When the temporary timer period is greater than or equal to the minimum scan timer period (Tmin), the temporary timer period is obtained in Step 720. When the temporary timer period is smaller than the minimum scan timer period (Tmin) in Step 716, the temporary timer period is set to the minimum scan timer period (Tmin) in Step 718, and the temporary timer period is obtained in Step 720.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A search method of a roaming service for registering a mobile station to a wireless communication network, comprising:
searching for a home public land mobile network (HPLMN) when the mobile station is first switched on or recovered from lack of service;
recording the HPLMN as a registered public land mobile network (RPLMN) when there is an available base station of the HPLMN and the available base station of the HPLMN supports a high-speed data transfer; and
searching for the RPLMN when the mobile station can not find the available base station of the HPLMN, or the available base station of the HPLMN does not support a high-speed data transfer, or a location registration to the HPLMN is unsuccessful, wherein searching for the RPLMN comprises registering to the RPLMN when the RPLMN is found and the location registration is necessary.

2. The search method of the roaming service of claim 1, wherein recording the HPLMN as the RPLMN further comprises examining whether the location registration is necessary, registering to the HPLMN when the location registration is necessary, and when the mobile station successfully performs the location registration to the HPLMN, recording the HPLMN as the RPLMN.

3. The search method of the roaming service of claim 1, wherein recording the HPLMN as the RPLMN further comprises examining whether the location registration is necessary, and when the location registration is not necessary, recording the HPLMN as the RPLMN.

4. A search method of a roaming service for registering a mobile station to a network service, comprising:
searching for a registered public land mobile network (RPLMN) when an record of the RPLMN is existing;
registering to the RPLMN when the record of the RPLMN is existing and the RPLMN is found and the location registration is necessary; and when the record of RPLMN is not existing, or the mobile station can not find the available base station of the RPLMN, or the location registration to the RPLMN is unsuccessful, or a scan timer expires, performing the steps of:
(a1) updating an available public land mobile network (PLMN) list; and
(a2) performing a location registration according to the available PLMN list,
wherein the step (a1) comprises sorting the available PLMNs according to an order of preferred PLMNs corresponding to a current location of the mobile station, or sorting the available PLMNs according to a data transfer speed they support.

5. The search method of the roaming service of claim 4, wherein the step (a1) further comprises determining the order of preferred PLMNs from a stored table wherein multiple of location-based orders of preferred PLMNs are stored.

6. The search method of the roaming service of claim 4, wherein the step (a1) further comprises sorting the available PLMN list in a descending order according to the data transfer speed supported by the available PLMNs such that the first PLMN in the available PLMN list supports the highest data transfer speed.

7. The search method of the roaming service of claim 4, wherein the step (a1) further comprises sorting the available PLMNs in a order such that 3G PLMNs are placed in front of 2G PLMNs.

8. A search method of a roaming service for registering a mobile station to a network service, comprising:
updating an available public land mobile network (PLMN) list;
determining whether a registered public land mobile network (RPLMN) is a home public land mobile network (HPLMN);
using a scaling method to update a scan timer period, obtain an temporary timer period; and
starting a scan timer with the temporary timer period when the RPLMN is not the HPLMN,
wherein the scaling method comprises examining a change ratio in the available PLMN list, or a data transfer speed of the RPLMN, or a status of Mobile Country Code (MCC).

9. The search method of the roaming service of claim 8, wherein the scaling method further comprises comparing a percentage changed in the available PLMN list and a predetermined ratio, and shortening the scan timer period when the percentage changed in the available PLMN list is greater than the predetermined ratio.

10. The search method of the roaming service of claim 9, wherein the scaling method further comprises examining whether the shortened scan timer period is greater than or equal to a minimum scan timer period, setting the scan timer period to the minimum scan timer period when the shortened scan timer period is smaller than the minimum scan timer period, and setting the temporary timer period to the value of the scan timer period.

11. The search method of the roaming service of claim 8, wherein the scaling method further comprises comparing a percentage changed in the available PLMN list and a predetermined ratio, and lengthening the scan timer period when the percentage changed in the available PLMN list smaller than the predetermined ratio.

12. The search method of the roaming service of claim 11, wherein the scaling method further comprises examining whether the lengthened scan timer period is smaller than or equal to a maximum scan timer period, setting the scan timer period to the maximum scan timer period when the lengthened scan timer period is greater than the maximum scan timer period, and setting the temporary timer period to the value of the scan timer period.

13. The search method of the roaming service of claim 8, wherein the scaling method further comprises setting the temporary timer period to the value of the scan timer period, examining whether the RPLMN supports the high-speed data transfer, and shortening the temporary timer period when the RPLMN does not support the high-speed data transfer.

14. The search method of the roaming service of claim 13, wherein the scaling method further comprises examining whether the shortened temporary timer period is greater than or equal to a minimum scan timer period, and when the shortened temporary timer period is smaller than the minimum scan timer period, setting the temporary timer period to the minimum scan timer period.

15. The search method of the roaming service of claim 8, wherein the scaling method further comprises setting the temporary timer period to the value of the scan timer period, examining whether the MCC of the RPLMN is the same as the MCC of the HPLMN, and shortening the scan timer period when the MCC of the RPLMN is different from the MCC of the HPLMN.

16. The search method of the roaming service of claim 15, wherein the scaling method further comprises further comprises examining whether the shortened temporary timer period is greater than or equal to a minimum scan timer period, and when the shortened temporary timer period is smaller than the minimum scan timer period, setting the temporary timer period to the minimum scan timer period.
